(19) United States
(12) Patent Application Publication
(10) Pub. No.: US 2023/0314251 A1
(43) Pub. Date: Oct. 5, 2023

(54) SELF-POWERED PRESSURE SENSOR BASED ON POSTBUCKLING

(71) Applicant: ZHEJIANG UNIVERSITY, Hangzhou (CN)

(72) Inventors: Pengcheng JIAO, Hangzhou (CN); Fan OUYANG, Hangzhou (CN); Yang YANG, Hangzhou (CN); Wentao LI, Hangzhou (CN)

(21) Appl. No.: 18/327,910

(22) Filed: Jun. 2, 2023

Related U.S. Application Data
(63) Continuation of application No. PCT/CN2021/133829, filed on Nov. 29, 2021.

(30) Foreign Application Priority Data
Dec. 4, 2020 (CN) 202011398243.7

(51) Int. Cl. G01L 9/00; G01L 19/00

(52) U.S. Cl. CPC G01L 9/008; G01L 19/0061

(57) ABSTRACT

The present invention belongs to the field of pressure sensors, and particular relates to a self-powered pressure sensor based on the phenomenon of post-buckling. The self-powered pressure sensor comprises a carrier module, an electric every storage module, a sensing information control module and a pressure sensing module, wherein the pressure sensing module comprises a base, a cover plate and a flexible piezoelectric patch; the cover plate is inserted into the base, a first elastic element is arranged between the cover plate and the base in a matching manner, and a mounting cavity is further defined between the cover plate and the base; and the flexible piezoelectric patch is arranged in the mounting cavity, the periphery of the flexible piezoelectric patch matches the mounting cavity in a limiting manner, and a second elastic element is arranged between the flexible piezoelectric patch and the cover plate in a matching manner.

### CROSS-REFERENCE TO RELATED APPLICATIONS

The present application is a continuation of International Application No. PCT/CN2021/133829, filed on Nov. 29, 2021, which claims priority to Chinese Application No. 202011398243.7, filed on Dec. 4, 2020, the contents of both of which are incorporated herein by reference in their entireties.

### TECHNICAL FIELD

The present disclosure relates to the technical field of pressure sensor and in particular, to a self-powered pressure sensor based on postbuckling.

### BACKGROUND

With the improvement of the intelligence of human society, a sensor plays an increasingly significant role in daily life as a source of information. The sensor may convert the sensing information into electrical signals or other information in a required form for output according to a certain rule to meet the requirements such as transmission, processing, storage, displaying, recording and control of information. At present, the applied sensors mainly include piezoelectric sensor, piezoresistive sensor and capacitive sensor according to different sensing principles. The piezoelectric sensor is produced based on piezoelectric effect generated by some dielectrics under force. Compared with the piezoresistive sensor and the capacitive sensor, the piezoelectric sensor has the advantages such as wide frequency band, high sensitivity, high signal-to-noise ratio, simple structure, reliable operation and light weight. Traditional piezoelectric sensors still play a significant role in many important fields. However, the defects of the traditional piezoelectric sensor are that some piezoelectric materials need moisture-proof measures, and the output DC response is poor. Therefore, a high input impedance circuit or a charge amplifier is needed to overcome the defects. As sensors have been more widely used in the field of intelligent robots and bioengineering, the requirements for the sensor become stricter. Therefore, it is necessary to design a new sensor that meets the requirements of the era.

In recent years, with the rapid development of the electronic device, the development potential of the new self-powered sensor in wearable devices, health monitoring, intelligent robots and other important fields has been widely concerned and studied. Compared with the prior art, the present disclosure provides a self-powered pressure sensor based on postbuckling, which may generate electrical energy through high-frequency pressure deformation. In addition to being configured for sensing, the self-powered pressure sensor may also meet the requirement of storing energy for energy supply. Compared with the traditional piezoelectric sensor, the self-powered pressure sensor has the advantages of flexibility, low power consumption, no power supply, and may play a significant role in the field of intelligent robots and bioengineering, for example, as a self-powered flexible patch for intelligent wearable devices.

### SUMMARY

In order to compensate the lacks in the prior art, the present disclosure provides a self-powered pressure sensor based on postbuckling.

The self-powered pressure sensor based on postbuckling includes a carrier module, an electrical energy storage module, a sensing information control module and a pressure sensing module provided at the carrier module. The pressure sensing module includes a base, a cover plate and a flexible piezoelectric sheet. The cover plate is inserted in the base, a first elastic element is provided between the cover plate and the base, and an installation cavity is further defined between the cover plate and the base. The flexible piezoelectric sheet is provided in the installation cavity, and the flexible piezoelectric sheet is fitted along its periphery with the installation cavity in a limiting manner. A second elastic element is and provided between the flexible piezoelectric sheet and the cover plate. When the cover plate is pressed downward, the flexible piezoelectric sheet may be pressed by the cover plate, deformed, and depressed downward under a postbuckling. When the flexible piezoelectric sheet is pressed, electrical energy may be generated and transmitted to the electrical energy storage module and the sensing information control module. The electrical energy storage module is configured to store electrical energy, and the sensing information control module is configured to analyze and process electrical signals.

In the self-powered pressure sensor based on postbuckling, the base includes a lower part base and an upper part base which is screwed and fixed with the lower part base. A peripheral edge of the flexible piezoelectric sheet is clamped between the lower part base and the upper part base.

In the self-powered pressure sensor based on postbuckling, a plurality of chutes are circularly provided at an inner wall of one of the upper part base and the cover plate, and a slider slidably matched with the chutes is circularly provided at an inner wall of the other one of the upper part base and the cover plate.

In the self-powered pressure sensor based on postbuckling, the first elastic element and the second elastic element are both made of springs. The first elastic element is connected between the slider and the chutes, and the second elastic element is connected between the middle part of the flexible piezoelectric sheet and the cover plate.

In the self-powered pressure sensor based on postbuckling, a boss is provided at the lower part base. When the flexible piezoelectric sheet is depressed downward, the boss may constrain the depression extent of the piezoelectric flexible sheet.

For the self-powered pressure sensor based on postbuckling, when the flexible piezoelectric sheet is in a normal state, a middle part of the flexible piezoelectric sheet is raised upward. When the flexible piezoelectric sheet causes postbuckling, the middle part of the flexible piezoelectric sheet is depressed downward.

In the self-powered pressure sensor based on postbuckling, both of the base and the cover plate are connected to the electrical energy storage module and the sensing information control module through a wire.

In the self-powered pressure sensor based on postbuckling, the carrier module is covered with pressure sensing modules.

In the self-powered pressure sensor based on postbuckling, a groove for installing the pressure sensing module is provided at the carrier module.

For the self-powered pressure sensor based on postbuckling, the electrical energy storage module and the sensing information control module are provided at two sides of the carrier module, respectively.

Compared with the prior art, the self-powered pressure sensor according to the present disclosure provides power supply through high-frequency pressure deformation. Compared with the traditional piezoresistive sensor, piezoelectric sensor and capacitive sensor, the self-powered pressure sensor has the advantages such as low power consumption, flexibility, and no power supply. The present disclosure has great application value in the field of intelligent robots and bioengineering, such as the self-powered flexible patch for intelligent wearable devices.

### BRIEF DESCRIPTION OF DRAWINGS

FIG. 1 is a structural schematic diagram of the present disclosure;

FIG. 2 is a structural schematic diagram of a pressure sensing module according to the present disclosure;

FIG. 3 is a first structural schematic diagram of a pressure sensing module according to the present disclosure in a working state;

FIG. 4 is a second structural schematic diagram of a pressure sensing module according to the present disclosure in a working state;

FIG. 5 is a third structural schematic diagram of a pressure sensing module according to the present disclosure in a working state;

FIG. 6 is a first schematic diagram of the present disclosure in a working state; and

FIG. 7 is a second schematic diagram of the present disclosure in a working state.

### DESCRIPTION OF EMBODIMENTS

In the description of the present disclosure, it should be understood that the orientation or position relationship indicated by the terms “one end”, “the other end”, “outer side”, “up”, “inner side”, “horizontal”, “coaxial”, “center”, “end”, “length”, “outer end”, etc. is based on the orientation or position relationship shown in the drawings, which is only for the convenience of describing the present disclosure and simplifying the description, rather than indicating or implying that the device or element referred to must have a specific orientation, or be constructed and operated in a specific orientation. Therefore, the orientation or position relationship should not be construed as a limitation of the present disclosure.

The present disclosure is further described below with the drawings.

As shown in the figures, a self-powered pressure sensor based on postbuckling includes a carrier module 2, an electrical energy storage module 1, a sensing information control module 3 and a pressure sensing module 4 provided at the carrier module 2. The pressure sensing module 4 includes a base, a cover plate 401 and a flexible piezoelectric sheet 410. The cover plate 401 is inserted in the base, a first elastic element 408 is provided between the cover plate 401 and the base, and an installation cavity is further defined between the above two. The flexible piezoelectric sheet 410 is provided in the installation cavity, and is fitted with the installation cavity in a limiting manner. A second elastic element 413 is provided between the flexible piezoelectric sheet 410 and the cover plate 401. When the cover plate 401 is pressed downward, the flexible piezoelectric sheet 410 may be pressed by the cover plate 401, deformed, and depressed downward under a postbuckling. When the flexible piezoelectric sheet 410 is pressed, electrical energy may be generated and transmitted to the electrical energy storage module 1 and the sensing information control module 3. The electrical energy storage module 1 is configured to store electrical energy, and the sensing information control module 3 is configured to analyze and process electrical signals. The sensing information control module 3 may include an analog-to-digital converter, a microcontroller, and a calculator. The flexible piezoelectric sheet 410 is a piezoelectric polymer.

In an embodiment, the base includes a lower part base 404 and an upper part base 403 which is screwed and fixed with the lower part base 404. A peripheral edge of the flexible piezoelectric sheet 410 is clamped between the lower part base 404 and the upper part base 403. The lower part base 404 is a cylindrical structure with a closed bottom, and the upper part base 403 is a corresponding tubular structure.

In an embodiment, a plurality of chutes 407 are circularly provided at an inner wall of one of the upper part base 403 and the cover plate 401, and a slider 406 slidably fitted with the plurality of chutes 407 is circularly provided at an inner wall of the other one of the upper part base 403 and the cover plate 401. In an embodiment, the slider 406 is evenly arranged around the bottom of the cover plate 401, and the chutes 407 are evenly arranged at the inner wall of the upper part base 403.

In an embodiment, the first elastic element 408 and the second elastic element 413 are both made of springs. The first elastic element 408 is connected between the slider 406 and the chutes 407, and the second elastic element 413 is connected between the middle part of the flexible piezoelectric sheet 410 and the cover plate 401.

In an embodiment, a boss 412 protruding from a bottom wall surface of the lower part base 404 is provided at the lower part base 404. When the flexible piezoelectric sheet 410 is depressed downward, the boss 412 may constrain the depression extent of the piezoelectric flexible sheet 410.

In an embodiment, when the flexible piezoelectric sheet 410 is in a normal state (i.e., the state when the flexible piezoelectric sheet 410 is clamped in the base without being pressed by the cover plate 401, rather than the state when the flexible piezoelectric sheet 410 is fully expanded), a middle part of the flexible piezoelectric sheet 410 is raised upward. When the flexible piezoelectric sheet 410 causes postbuckling, the middle part of the flexible piezoelectric sheet 410 is depressed downward.

In an embodiment, both of the lower part base 404 and the cover plate 401 are connected to the electrical energy storage module 1 and the sensing information control module 3 through a wire. In an embodiment, the cover plate 401 is connected to the electrical energy storage module 1 and the sensing information control module 3 through a first wire 402, and the lower part base 404 is connected to the sensing information control module 3 through a second wire 405.

In an embodiment, the carrier module 2 is covered with pressure sensing modules 4.

In an embodiment, a groove 5 for installing the pressure sensing module 4 is provided at the carrier module 2.

In an embodiment, the electrical energy storage module 1 and the sensing information control module 3 are provided at two sides of the carrier module 2, respectively.

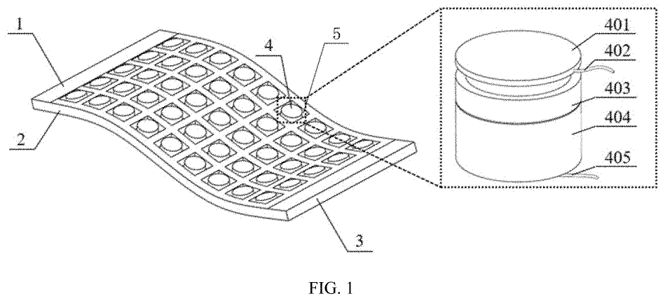

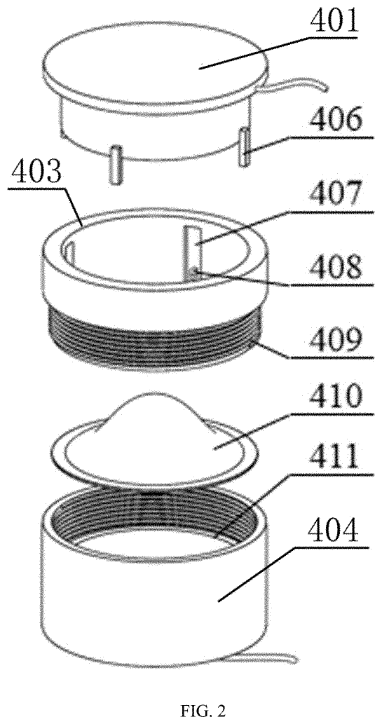

The working principle of the self-powered pressure sensor is illustrated in FIGS. 1 and 2 as examples. When high-frequency deformation pressure is applied from the outside, the cover plate 401 that may be pressed moves downward. The slider 406 of the cover plate 401 contacts the first elastic element 408 and then bounces up. In this process, the slider 406 drives the flexible piezoelectric sheet 410 to deform and recover, and the process is repeated due to the piezoelectric effect to generate electrical energy. The diameter of the flexible piezoelectric sheet 410 that may cause postbuckling is greater than that of the base. In the installation process, when the flexible piezoelectric sheet 410 is inserted into the base, the middle part of the flexible piezoelectric sheet 410 protrudes upward. External thread 409 is provided at the upper part base 403, and internal thread 411 is provided at the lower part base 404, which are configured to constrain and fix the flexible piezoelectric sheet 410. Before the cover plate 401 moves downward, the protuberant part of the flexible piezoelectric sheet 410 contacts the cover plate 401. When the cover plate 401 moves downward under pressure, the flexible piezoelectric sheet 410 changes from being protruded upward to being depressed downward, and the depression part contacts the boss 412. The cover plate 401 and the boss 412 are equivalent to the positive and negative poles of a power supply, respectively. After the flexible piezoelectric sheet 410 contacts the boss 412, the electrical energy is transmitted to the boss 412 and then transmitted through the second wire 405. The generated electrical energy is stored in the electrical energy storage module 1.

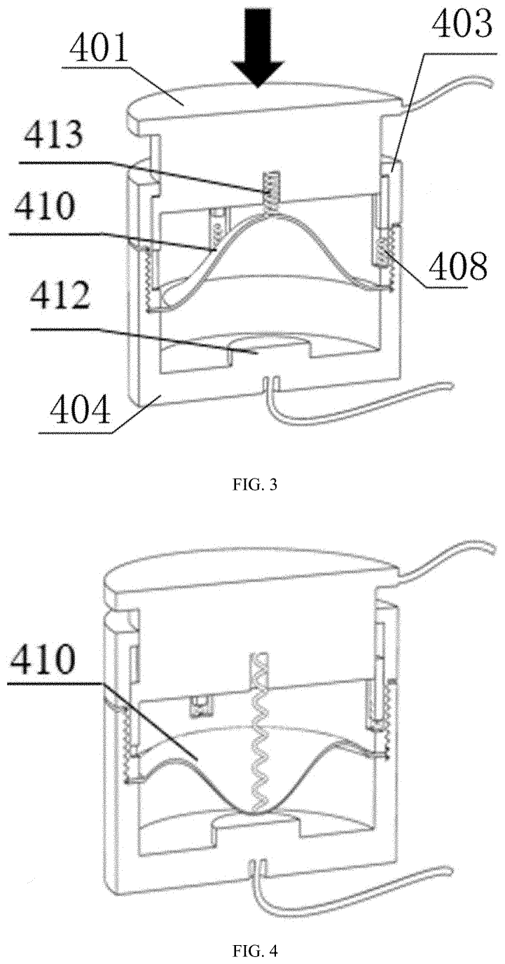

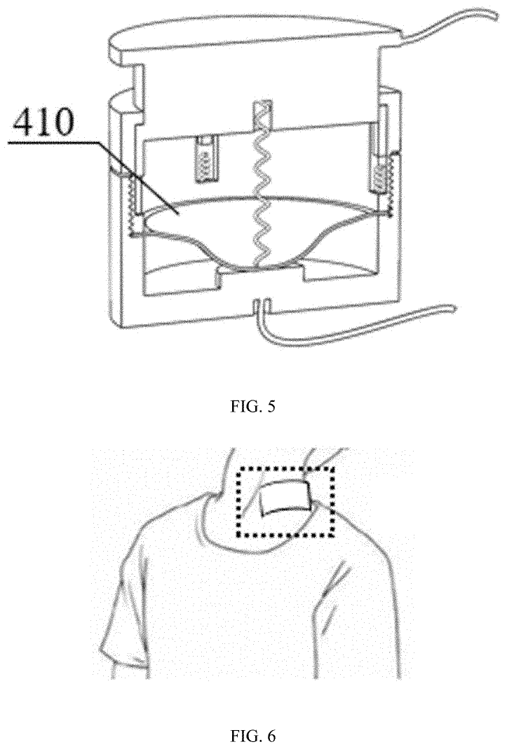

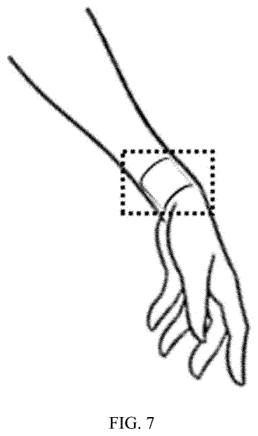

The three states of the self-powered pressure sensor is illustrated in FIGS. 3-5 as examples. When a force is just applied, the flexible piezoelectric sheet 410 contacts the cover plate 401. At this time, the second elastic element 413 between the flexible piezoelectric sheet 410 and the cover plate 401 is in a natural tensile state and does not bear the tension of the flexible piezoelectric sheet 410. As the cover plate 401 is pressed downward, the flexible piezoelectric sheet 410 changes from being protruded upward to being depressed downward. The flexible piezoelectric sheet 410 is just in contact with the boss 412. At this time, the second elastic element 413 above the flexible piezoelectric sheet 410 is in a tensile state, but the cover plate 401 is in a lower position, the tension of the second elastic element 413 to the flexible piezoelectric sheet 410 is not great yet, and the flexible piezoelectric sheet 410 continues being pressed downward to contact the boss 412. FIG. 5 shows a contact state in which the flexible piezoelectric sheet 410 and the boss 412 is finally a stable state. At this time, electrical energy is transmitted continuously. In this process, since the cover plate 401 is bounced upward by the first elastic element 408, the more the cover plate 401 moves upward, the greater the tension that the cover plate 401 exerts on the second elastic element 413 is. When the tension reaches a certain degree, the second elastic element 413 pulls the flexible piezoelectric sheet 410 up and returns to the initial state.

The self-powered pressure sensor based on postbuckling according to the present disclosure may transform high-frequency pressure deformation into electrical energy, and transmit electrical energy through the material with postbuckling to realize self-energy storage. The pressure sensor has the advantages such as flexibility, low power consumption, and no power supply, and may store and supply energy by itself. The invention according to the design may function independently and supply energy by itself, which greatly improves the applicability of the present disclosure and makes the present disclosure have great application value in the field of intelligent robots and bioengineering. The present disclosure may be stuck at the pulse of the human body to detect the pulse of the human body.

Finally, it should be noted that the above embodiments are only used to illustrate the technical solutions according to the present disclosure, not to limit it. Although the present disclosure has been described in detail with reference to the above-mentioned embodiments, those skilled in the art should understand that the technical solutions recorded in the above-mentioned embodiments may still be amended, or some or all of the technical features thereof may be replaced equivalently. However, the amendments or replacements do not make the essence of the corresponding technical solutions separate from the scope of the technical solutions according to the embodiments of the present disclosure.

What is claimed is:

1. A self-powered pressure sensor based on postbuckling, comprising:
an electrical energy storage module (1) configured to store electrical energy,
a carrier module (2),
a sensing information control module (3) configured to analyze and process electrical signals, and
a pressure sensing module (4) provided at the carrier module (2);
wherein the pressure sensing module (4) comprises:
a base,
a cover plate (401) inserted in the base, and
a flexible piezoelectric sheet (410);
wherein a first elastic element (408) is provided between the cover plate (401) and the base, an installation cavity is defined between the cover plate (401) and the base, the flexible piezoelectric sheet (410) is provided in the installation cavity, and is fitted along its periphery with the installation cavity in a limiting manner, and a second elastic element (413) is provided between the flexible piezoelectric sheet (410) and the cover plate (401),
wherein when the cover plate (401) is pressed downward, the flexible piezoelectric sheet (410) is pressed by the cover plate (401), deformed, and depressed downward under a postbuckling; when the flexible piezoelectric sheet (410) is in a normal state, a middle part of the flexible piezoelectric sheet (410) is raised upward; when the flexible piezoelectric sheet (410) is under the postbuckling, the middle part of the flexible piezoelectric sheet (410) is depressed downward; when the flexible piezoelectric sheet (410) is pressed, electrical energy is generated and transmitted to the electrical energy storage module (1) and the sensing information control module (3).

2. The self-powered pressure sensor based on postbuckling according to claim 1, wherein the base comprises a lower part base (404) and an upper part base (403) screwed and fixed with the lower part base (404); a peripheral edge of the flexible piezoelectric sheet (410) is clamped between the lower part base (404) and the upper part base (403).

3. The self-powered pressure sensor based on postbuckling according to claim 2, wherein a plurality of chutes (407) are circularly provided at an inner wall of one of the upper part base (403) and the cover plate (401), and a slider (406) matched with the chutes (407) in a slide way is circularly provided at an inner wall of the other one of the upper part base (403) and the cover plate (401).

4. The self-powered pressure sensor based on postbuckling according to claim 2, wherein the first elastic element (408) and the second elastic element (413) are both made of springs, the first elastic element (408) is connected between the slider (406) and the chutes (407), and the second elastic element (413) is connected between the middle part of the flexible piezoelectric sheet (410) and the cover plate (401).

5. The self-powered pressure sensor based on postbuckling according to claim 2, wherein a boss (412) is provided at the lower part base (404); when the flexible piezoelectric sheet (410) is depressed downward, the boss (412) is capable of constraining the depression extent of the piezoelectric flexible sheet (410).

6. The self-powered pressure sensor based on postbuckling according to claim 1, wherein both of the base and the cover plate (401) are connected to the electrical energy storage module (1) and the sensing information control module (3) through a wire.

7. The self-powered pressure sensor based on postbuckling according to claim 1, wherein the carrier module (2) is densely covered with pressure sensing modules (4).

8. The self-powered pressure sensor based on postbuckling according to claim 1, wherein a groove (5) for installing the pressure sensing module (4) is provided at the carrier module (2).

9. The self-powered pressure sensor based on postbuckling according to claim 1, wherein the electrical energy storage module (1) and the sensing information control module (3) are provided at two sides of the carrier module (2), respectively.
